(19) United States
(12) Patent Application Publication
(10) Pub. No.: US 2019/0144568 A1
(43) Pub. Date: May 16, 2019

(54) CHITOSAN COAGULANT AS A BINDER AND DUST CONTROL AGENT

(71) Applicant: General Electric Company, Schenectady, NY (US)

(72) Inventors: Michael T. RAAB, Trevose, PA (US); Wendy A. SEGAL, Trevose, PA (US)

(21) Appl. No.: 16/098,676

(22) PCT Filed: May 27, 2016
(86) PCT No.: PCT/US2016/034545

§ 371 Date: Nov. 2, 2018

(51) Int. Cl. C08B 37/08; C08L 51/02; E01H 3/00; E21F 5/00

(52) U.S. Cl. CPC C08B 37/003; E21F 5/00; E01H 3/00; C08L 51/02

(57) ABSTRACT

Methods for stabilizing a friable substrate using a dust suppressant composition comprising a poly-(METAS)-Chitosan polymer.

### FIELD OF THE INVENTION

This disclosure relates to compositions and methods for suppressing dust emissions and more particularly to bio-friendly dust suppressants and methods.

### BACKGROUND OF THE INVENTION

Treating the surfaces of friable materials with dust suppressants that stabilize the materials may reduce air pollution and product loss. Dust clouds form when small minute particles become airborne and can be created by equipment or movement over areas containing loose dry particles. Dust from windy weather conditions or traffic on unpaved roads or from handling, storage and transfer of particulate matter, such as in bulk solids storage areas, poses environmental, health and safety issues. Dust clouds can cause or aggravate respiratory conditions and lead to production losses through equipment breakdown and premature wearing of machine parts. Dust clouds on unpaved roads can cause poor visibility and dangerous driving conditions. Some dust, such as coal dust may cause explosions.

Numerous dust control products or dust suppressants are available and can be used to settle particles and prevent them from scattering. Known dust reduction agents contain phospholipids for granular inorganic substances, such as fertilizers. Others use a soy-based binder material for soil stabilization and dust suppressant.

Some known dust suppressants, however, can be toxic to the environment. Many non-toxic alternatives may be too costly to treat large expansive areas, such as roads.

### BRIEF DESCRIPTION OF THE INVENTION

It was surprisingly discovered that compositions comprising a poly-(METAS)-Chitosan polymer are effective dust suppressants. The poly-(METAS)-Chitosan polymer can be inexpensive and are environmentally-friendly. Accordingly, in one embodiment, a method for stabilizing a friable substrate using a dust suppressant composition comprising poly-(METAS)-Chitosan polymer is disclosed. The poly(METAS)-Chitosan polymer may have repeating units of:

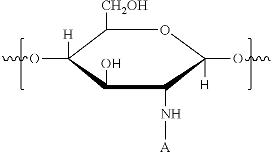

wherein A has the formula of:

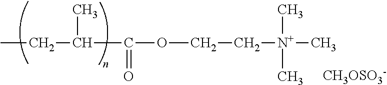

and wherein n is an integer from 50 to 5000.

The poly(METAS)-Chitosan polymer may have a viscosity in the range of from about 500 cps to about 3000 cps. In another embodiment, the poly(METAS)-Chitosan polymer may comprise from about 5 wt % to about 30 wt % chitosan and from about 25 wt % to about 75 wt % of 2-Methacryloyloxyethyltrimethyl ammonium methyl sulfate.

In another embodiment, the dust suppressant composition may comprise from about 3% to about 50% solids of said poly(METAS)-Chitosan polymer based on a total solids content of said dust suppressant composition.

The dust suppressant composition may be used to stabilize any friable substrate, including but not limited to, an unpaved surface or coal. In one embodiment, the friable substrate may be an unpaved surface. In another embodiment, the friable substrate may be coal.

The concentration and amount of dust suppressant used to stabilize the friable surface will vary with surface type and the condition of the surface itself. When the friable surface is an unpaved surface and the dust suppressant composition may comprise from about 10% to about 50% solids of the poly(METAS)-Chitosan polymer based on a total solids content of the dust suppressant composition. The dust suppressant composition may be added to the unpaved surface at a concentration ranging from about 0.1 to about 2.0 gallons per square yard of the unpaved surface.

When the friable surface is coal, the dust suppressant composition may comprise from about 2% to about 15% solids of said poly(METAS)-Chitosan polymer based on a total solids content of the dust suppressant composition. The dust suppressant composition may be added to the coal at a concentration ranging from about 1% to about 20% moisture by weight of a total weight of the coal.

### DETAILED DESCRIPTION OF EXEMPLARY EMBODIMENTS

In one embodiment, a method for stabilizing a friable substrate using a dust suppressant composition comprising poly-(METAS)-Chitosan polymer is disclosed. The poly(METAS)-Chitosan polymer may have repeating units of:

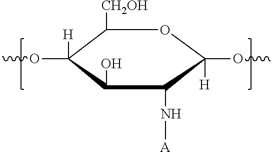

wherein A has the formula of:

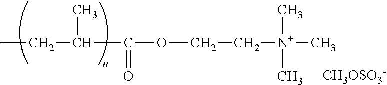

and wherein n is an integer from 50 to 5000. In another embodiment, n is an integer from 100 to 1000. In another embodiment, n is an integer from 100 to 500.

In one embodiment, poly(METAS)-Chitosan polymer has a viscosity measured at 25 ° C. in the range of from about 500 cps to about 3000 cps. In another embodiment, the poly(METAS)-Chitosan polymer has a viscosity in the range of from about 500 cps to about 2000 cps. In yet another embodiment, the poly(METAS)-Chitosan polymer has a viscosity in the range of from about 500 cps to about 1500 cps.

In one embodiment, the poly(METAS)-Chitosan polymer includes 2-methacryloyloxyethyltrimethyl ammonium methyl sulfate groups grafted onto a chitosan backbone. The grafted groups improve the performance of the chitosan polymer by increasing the percent actives of the product while maintaining the solubility of the product in water at high mole ratios of chitosan. Details of the grafting polymer and grafting process have been omitted for the sake of brevity. More information may be found in Patent Application No. WO 2011/156097 A2, herein incorporated by reference.

Chitosan is a linear polysaccharide containing deacetylated units and acetylated units. In one embodiment, the deacetylated unit may be β-(1-4)-linked D-glucosamine. In another embodiment, the acetylated unit may be N-acetyl-D-glucosamine units. Chitosan may be prepared by deacylating chitin with a strong alkali and is available commercially from India Sea Foods. Chitosan may be present from about 5 wt % to about 30 wt %, based on a total weight of the polymer. In another embodiment, chitosan may be present from about 10 wt % to about 30 wt % based on a total weight of the polymer. Alternatively, the chitosan may range from about 20 wt % to about 30 wt %.

2-Methacryloyloxyethyltrimethyl ammonium methyl sulfate is available commercially, such as from Ciba. 2-Methacryloyloxyethyltrimethyl ammonium methyl sulfate may be present from about 25 wt % to about 75 wt %, based on the weight of the polymer. In another embodiment, 2-Methacryloyloxyethyltrimethyl ammonium methyl sulfate may be present from about 30 wt % to about 70 wt % based on a total weight of the polymer. In yet another embodiment, 2-Methacryloyloxyethyltrimethyl ammonium methyl sulfate may be present from about 35 wt % to about 65 wt %.

The dust suppression composition may be used to stabilize any friable substrate. As used herein, stabilize means to reduce the amount of dust that becomes airborne. Without limiting the theory of operation to the theory disclosed herein, the dust suppressant composition may stabilize the friable substrate by binding dust particles together to form heavier agglomerates. Friable substrates may include, but are not limited to, unpaved surfaces, such as roads, trails, driveways, campgrounds, construction sites, mining sites, and industrial sites. Additional friable substrates may include, but are not limited to, industrial product or waste piles made from materials such as sawdust, sand, coal, lignite, peat, and tailing pond fines. The dust suppression may be applied to the friable substrate using any method known to those of ordinary skill in the art.

The concentration and amount of dust suppressant used to stabilize the friable surface will vary with surface type and the condition of the surface itself. When the friable surface is an unpaved surface, the dust suppressant composition may comprise from about 10% to about 50% solids of the poly(METAS)-Chitosan polymer based on a total solids content of the dust suppressant composition. The dust suppressant composition may be added to the unpaved surface at a concentration ranging from about 0.1 to about 2.0 gallons per square yard of the unpaved surface.

When the friable surface is coal, the dust suppressant composition may comprise from about 2% to about 15% solids of the poly(METAS)-Chitosan polymer based on a total solids content of the dust suppressant composition. The dust suppressant composition may be added to the coal at a concentration ranging from about 1% to about 20% moisture by weight of a total weight of the coal.

### EXAMPLES

Exemplary dust suppressant compositions comprising from about 3 to about 50% solids by weight of a poly(METAS)-Chitosan polymer in water were prepared, and tests were performed in the lab to simulate how the compositions would perform in both a road surface application and in a coal dust application.

### Example Set 1

### Road Surface Application

For the Example Set 1, various dust suppressant compositions were applied to a synthetic road substrate to evaluate the compositions' binding strength. The synthetic road substrate comprised 70% sand passed through a 30-mesh sieve (−30 mesh) and 30% montmorillonite clay retained on an 18-mesh sieve and passed through a 30-mesh sieve (+18/−30 mesh).

Aqueous solutions, Ex 1-1, Ex 1-2, and Ex 1-3, of the poly(METAS)-Chitosan dust suppressant compositions were prepared at 12.5, 25, and 50% solids respectively. The comparative solution, Comp 1-1, was an aqueous solution comprising 28.5% solids lignosulfonate salt. The exemplary and comparative dust suppressant compositions were then added to the substrate at a concentration of about 0.4 gal/yd² and mixed thoroughly with a small spatula for 1 minute.

The various treated substrates were transferred to a small aluminum pan. The treated substrates were distributed evenly to create a fairly smooth surface. Some of the substrates were compressed with 1000 lb_{f}. The treated substrates were then cured at 185° F. for two hours and then allowed to cool to room temperature.

The treated substrates were then tested with a Brookfield CT3 Texture Analyzer. The texture analyzer measures the strength of test substrates by sending a probe into the surface of the test substrates and using a load cell to measure the resistance encountered by the probe. The resistance may be used to determine the peak hardness (g) of the treated substrates and the hardness work done (mJ). The peak hardness and hardness work done may be used to evaluate the dust suppressant compositions' binding strength.

The test results for the uncompressed substrates are shown in Table 1. The test results for the compressed substrates are shown in Table 2.

TABLE 1
Uncompressed

| | | | Hardness Work |
|---|---|---|---|
| Example/Treatment | Solution % | Peak Hardness (g) | Done (mJ) |
| Comp 1-1 | 28.5 | 2890 | 168.64 |
| Ex 1-1 | 12.5 | 910 | 47.22 |
| Ex 1-1 | 12.5 | 880.5 | 45.08 |
| Ex 1-1 | 12.5 | 725 | 38.39 |
| Ex 1-1 | 12.5 | 1009.5 | 49.92 |

TABLE 2
Compressed

| Example/ | | | Hardness Work |
|---|---|---|---|
| Treatment | Solution % | Peak Hardness (g) | Done (mJ) |
| Comp 1-1 | 28.5 | 3912 | 200.62 |
| Ex 1-2 | 25 | 4969 | 185.25 |
| Ex 1-3 | 50 | *over machine max | *over machine max |

*The CT3 4500 Texture Analyzer can only measure a maximum of 5000 g.

### Example Set 2

### Coal Dust Application

For the Example Set 2, various dust suppressant compositions were applied to Powder River Basin sub-bituminous coal to evaluate the compositions' ability to agglomerate fine particles and control coal dust. The coal substrate was classified into various particle size distributions by passing the coal through a series of sieves as noted in Tables 3 and 4 below. The coal substrate was classified to generate enough dust to get meaningful dust reduction values.

Aqueous solutions, Ex 2-1 and Ex 2-2, of the poly(METAS)-Chitosan dust suppressant compositions were prepared at 3 and 10% solids respectively. The comparative solution, Comp 2-1, was an aqueous solution comprising 10% solids cationic polyacrylamide. DI water was used as the control. The exemplary and comparative dust suppressant compositions and the control were then added to the coal substrate at a concentration of 10 wt % moisture based on the total weight of coal. The moist coal substrates were then mixed thoroughly with a small spatula for 1 minute. The moist samples were allowed to dry for 24 hours at room temperature before testing.

The coal samples were then tested with a DustMon L dust chamber to quantify the dust suppression. The sample is dropped into the unit chamber and the unit measures the light transmission in the chamber. The transmission is used to determine the concentration of dust (%). The unit measures the dust index; namely the maximum dust concentration (%) plus the dust concentration (%) after 30 seconds. The dust area is also calculating by measuring the area under the dust concentration curve.

The test results for 3%-solutions are shown in Table 3. The test results for 10%-solutions are shown in Table 2.

TABLE 3
3% Solutions

| Example/ | | | | Dust |
|---|---|---|---|---|
| Treatment | Substrate | Solution % | Dust Index % | Area |
| Control | −100/+200 mesh | — | 125 | 1476.1 |
| Ex 2-1 | −100/+200 mesh | 3 | 97.2 | 1115.9 |
| Control | 50% −6/+10 | — | 6.3 | 91.3 |
| | 50% −10/+50 mesh | | | |
| Ex 2-1 | 50% −6/+10 | 3 | 2.4 | 36.3 |
| | 50% −10/+50 mesh | | | |

TABLE 4
10% Solutions

| Example/ | | | | |
|---|---|---|---|---|
| Treatment | Substrate | Solution % | Dust Index | Dust Area |
| None | 37.5% −6/+10 | — | 89.1 | 1081.5 |
| | 37.5% −10/+50 | | | |
| | 25% −100/+200 | | | |
| | mesh | | | |
| Control | 37.5% −6/+10 | — | 84.5 | 1021 |
| | 37.5% −10/+50 | | | |
| | 25% −100/+200 | | | |
| | mesh | | | |
| Ex 2-2 | 37.5% −6/+10 | 10 | 37.2 | 460.9 |
| | 37.5% −10/+50 | | | |
| | 25% −100/+200 | | | |
| | mesh | | | |
| Ex 2-2 | 37.5% −6/+10 | 10 | 37.3 | 409.8 |
| | 37.5% −10/+50 | | | |
| | 25% −100/+200 | | | |
| | mesh | | | |
| Comp 2-1 | 37.5% −6/+10 | 10 | 62.7 | 819 |
| | 37.5% −10/+50 | | | |
| | 25% −100/+200 | | | |
| | mesh | | | |

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A method of stabilizing a friable substrate, said method comprising contacting said friable substrate with a dust suppressant composition comprising a poly(METAS)-Chitosan polymer having repeating units of: 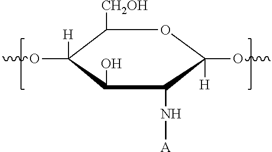
wherein A has the formula of: 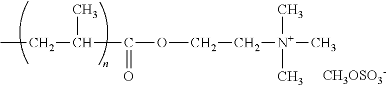
and wherein n is an integer from 50 to 5000.

2. The method of claim 1, wherein said poly(METAS)-Chitosan polymer has a viscosity in the range of from about 500 cps to about 3000 cps.

3. The method of claim 2, wherein said poly(METAS)-Chitosan polymer comprises from about 5 wt % to about 30 wt % chitosan and from about 25 wt % to about 75 wt % of 2-Methacryloyloxyethyltrimethyl ammonium methyl sulfate.

4. The method of claim 1, wherein said dust suppressant composition comprises from about 3% to about 50% solids of said poly(METAS)-Chitosan polymer based on a total solids content of said dust suppressant composition.

5. The method of claim 1, wherein said friable substrate is an unpaved surface.

6. The method of claim 5, wherein said dust suppressant composition comprises from about 10% to about 50% solids of said poly(METAS)-Chitosan polymer based on a total solids content of said dust suppressant composition.

7. The method of claim 5, wherein said dust suppressant composition is added to said unpaved surface at a concentration ranging from about 0.1 to about 2.0 gallons per square yard of said unpaved surface.

8. The method of claim 1, wherein said friable substrate is coal.

9. The method of claim 8, wherein said dust suppressant composition comprises from about 2% to about 15% solids of said poly(METAS)-Chitosan polymer based on a total solids content of said dust suppressant composition.

10. The method of claim 8, wherein said dust suppressant composition is added to said coal at a concentration ranging from about 1% to about 20% moisture by weight of a total weight of said coal.
